(19) United States
(12) Patent Application Publication
(10) Pub. No.: US 2011/0148984 A1
(43) Pub. Date: Jun. 23, 2011

(54) Direct Remote Analog/Digital Printing Devices, Processes and Mediums

(76) Inventor: Hans O. Ribi, Hillsborough, CA (US)

(21) Appl. No.: 12/958,084

(22) Filed: Dec. 1, 2010

Related U.S. Application Data
(63) Continuation of application No. 11/240,648, filed on Sep. 29, 2005, now abandoned.
Application No. 11/240,648 is a continuation-in-part of application No. PCT/US2004/010128, filed on Mar. 31, 2004.
(60) Provisional application No. 60/459,499, filed on Mar. 31, 2003.

(51) Int. Cl. B41J 23/00

(52) U.S. Cl. 347/37

(57) ABSTRACT

Direct remote digital/analog printing devices and mediums have been developed, which are capable of directly digitally printing on non-uniform or uniform substrate/mediums. Examples of devices are also capable of recognizing wireless digital or analog signals for processing and printing or directly scanning substrates using information (analog or digitally) encoded. The read/write devices can be remote and operate separately or can be attached to existing communications devices and products.

### CROSS-REFERENCE TO RELATED APPLICATIONS

This application is a continuation-in-part of application no. PCT/US04/10128 filed Mar. 31, 2004, which application claims priority (pursuant to 35 U.S.C. §119 (e)) to the filing date of the U.S. Provisional Patent Application Ser. No. 60/459,499 filed Mar. 31, 2003; the disclosures of which applications are herein incorporated by reference.

### BACKGROUND

In many cases it is desirable to remove restrictions placed on existing analog and digital printing process. For example, printing processes are restricted to a continuous linear motion. Digital print heads are designed to function in a fixed position or to be moved from side-to-side, using precise mechanisms within a printing apparatus. In many cases it is not practical to bring fixed printing equipment to remote locations. Hand-held printers exist, but are typically a part of a compete unit such as a hand-held receipt generator.

In inventory control or at supermarkets, it would be desirable to have a remote digital printing process, which combines wireless communicated information, dating information and other relevant storage information on demand.

Most printing processes require flat planar surfaces for printing. Often it would be desirable to print on non-uniform compliant surfaces, rather than be restricted to common planar surfaces. For example, packages are often folded or creased. Meat products in the dairy case usually have a non-planar surface.

In many instances it would be desirable to print on non-conventional surfaces to improve visual effects. Currently, there are no convenient digital processes and applicable printing mediums for directly printing on skin. It would be important in many cases to provide a convenient, cost effective, fast, and accurate means to alter skin conditions and improve both the visual appearance and healthiness of skin using a printing means.

### SUMMARY OF THE INVENTION

Direct remote digital/analog printing devices and mediums have been developed, which are capable of directly digitally printing on non-uniform or uniform substrate/mediums. Examples of devices are also capable of recognizing wireless digital or analog signals for processing and printing or directly scanning substrates using information (analog or digitally) encoded. The read/write devices can be remote and operate separately or can be attached to existing communications devices and products.

Direct remote digital printing processes and compatible printing mediums capable of functioning with non-planar surfaces, capable of printing in multiple directions, and capable of producing high resolution printing results can find a multitude of uses not anticipated and not possible using conventional restricted printing processes and substrates.

### BRIEF DESCRIPTION OF THE DRAWINGS

FIG. 1 shows an analog color-shifting sketching device and printing medium. The device shown in FIG. 1A allows the user to create designs by manipulating a heating element with a pair of knobs. When the heating element is moved across a color-shifting medium, it creates designs such as those shown in FIG. 1B.

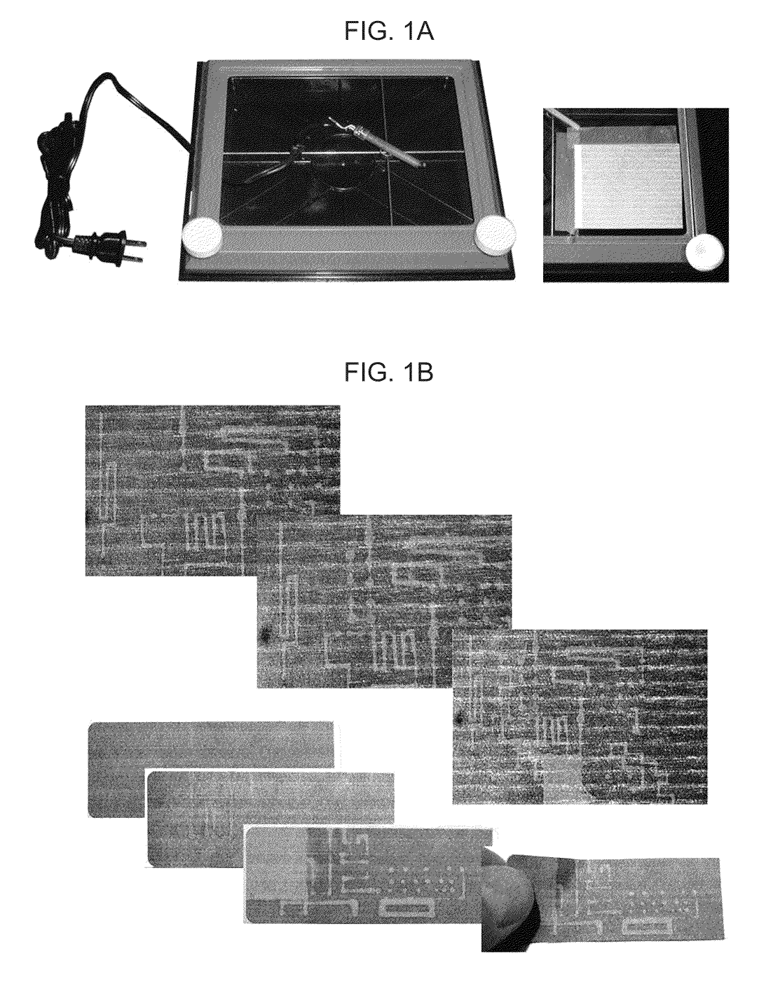

FIG. 2 shows an example of thermochromic intrinsically colored imprint paper. Graphics may be hidden or obscured, and later revealed by exposure to heat, or images may be created by using a thermal printing element.

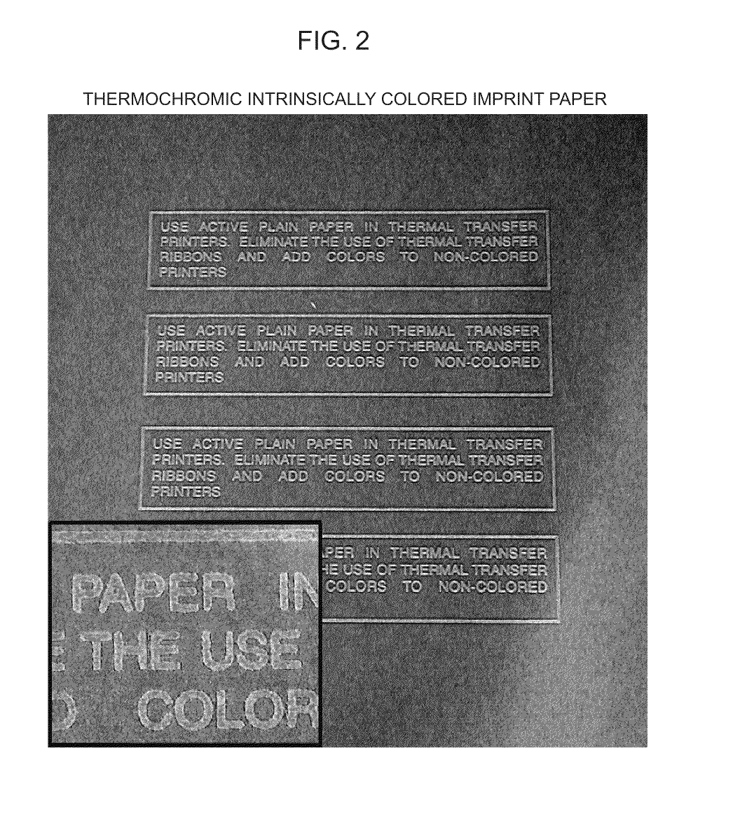

FIG. 3A shows a remote digital fingertip printer device. A modified thermal print head may be attached to the finger with adhesive and messages entered on an attached keypad.

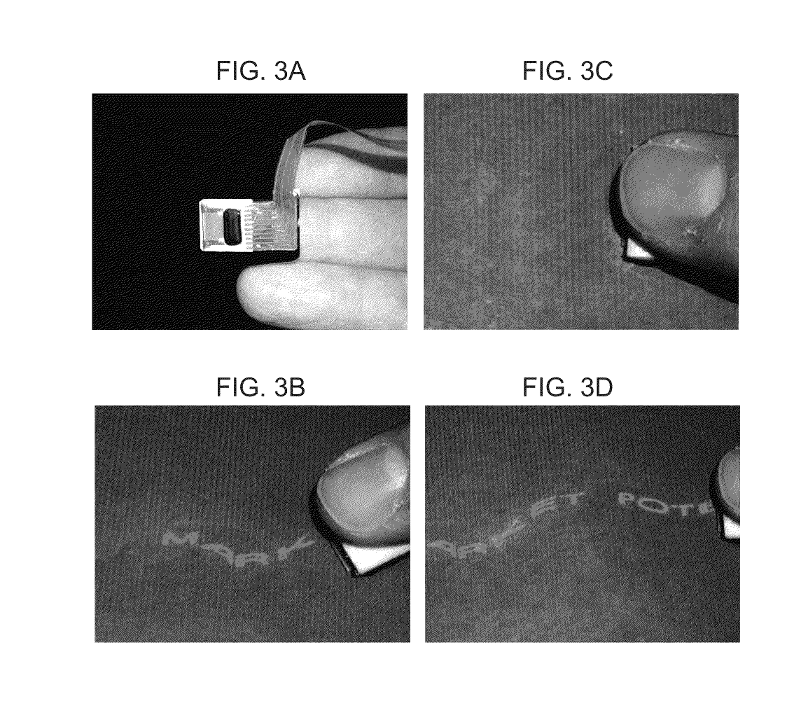

The device may then be used to print messages as it is moves across a color-shifting surface as shown in FIGS. 3B, 3C, and 3D.

FIGS. 4A and 4B show a color-shifting medium applied to the skin. Once the medium has been applied to the skin, a device such as the fingertip printer shown previously may be used to print messages on it as shown in FIGS. 4C, 4D, 4E, and 4F.

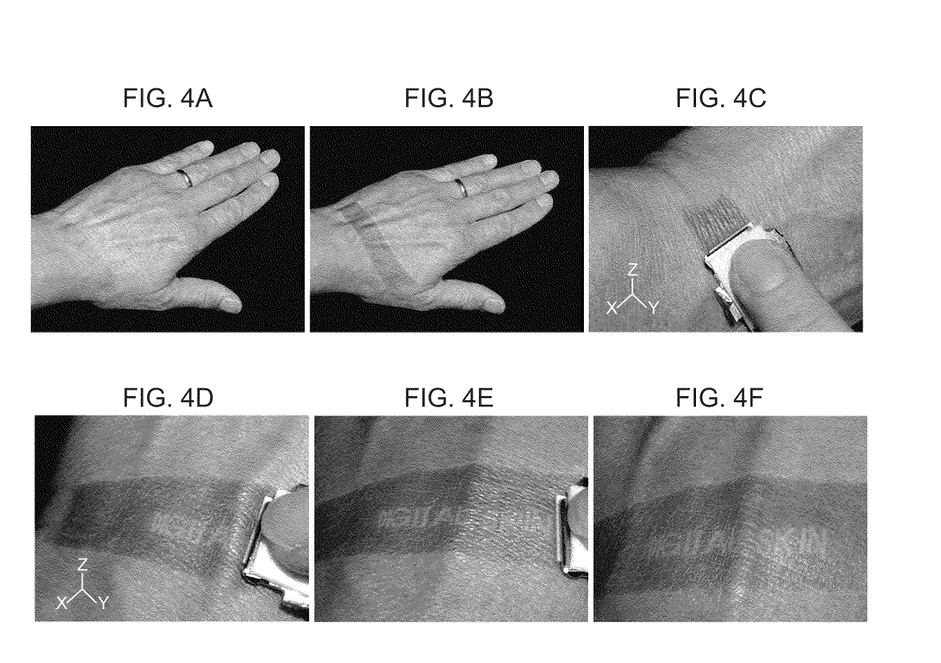

FIG. 5A shows how a color-shifting medium applied to the skin may undergo a subsequent color change when exposed to temperatures above or below body temperature. FIG. 5B shows a red color caused by exposure to warm water, while FIG. 5C shows a purple color caused by exposure to cold water.

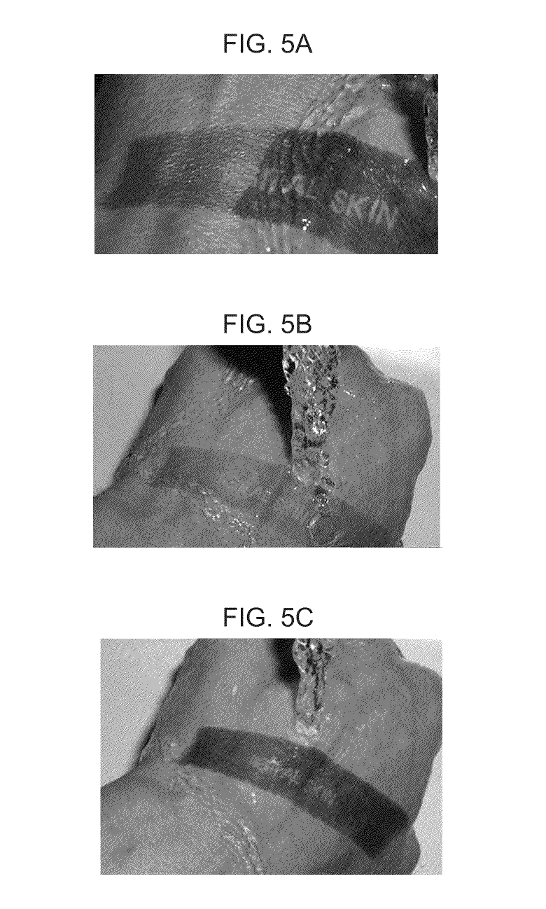

FIG. 6A shows a message formed by using the skin itself as a printing medium. The lettering is initially contrasted by the color-shifting medium, which may be washed off.

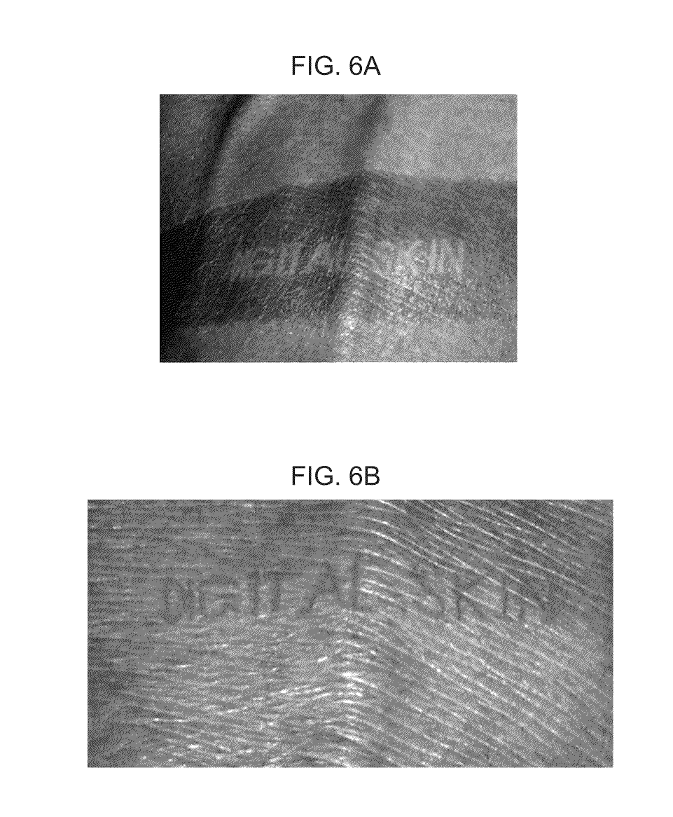

Whether or not a color-shifting medium is used, the message printed on the skin will remain darker than the surrounding skin, as shown in FIG. 6B.

### FEATURES OF THE INVENTION

The subject invention provides methods of printing on a substrate, where a feature of the methods is that a print head is moved across at least a portion of said substrate in an analog manner. In certain embodiments, the print head is moved across the substrate in a manner that varies with respect to at least the x direction. In certain embodiments, the print head is moved across the substrate in a manner that varies with respect to both the x and y directions. In certain embodiments, the print head is moved across the substrate in a manner that varies with respect to rate in at least one of the x and y directions. In certain embodiments, the print head is moved across the substrate in a manner that varies with respect to rate in both of the x and y directions. In certain embodiments, the print head is moved across the substrate in a non-linear manner. In certain embodiments, the print head is moved across the substrate in a curvilinear manner. In certain embodiments, the print head is manually moved across the substrate, either directly or indirectly. In certain embodiments, the print head is part of a device in which the print head has full range of motion in at least the x and y directions. In certain embodiments, the print head is part of a device in which the print head has full range of motion in the x, y and z directions. In certain embodiments, the print head is compliant.

In certain embodiments, the substrate is a non-uniform substrate. In certain embodiments, the print head is a not a fluid-deposition print head. In certain embodiments, the print head is part of a drawing device, e.g., a recreational drawing device. In certain embodiments, the print head is part of a digital fingertip printing device. In certain embodiments, the print head is part of a self-printing book device. In certain embodiments, the print head is part of a self-image printing camera attachment device. In certain embodiments, the print head is part of cellular telephone printing device. In certain embodiments, the print head is part of computer peripheral printer attachment device. In certain embodiments, the print head is part of digital skin augmentation device. Also provided are devices that can carry out or perform the above methods.

### DESCRIPTION OF REPRESENTATIVE SPECIFIC EMBODIMENTS

Direct remote digital/analog printing devices and mediums have been developed, which are capable of directly digitally printing on non-uniform or uniform substrate/mediums. Examples of devices are also capable of recognizing wireless digital or analog signals for processing and printing or directly scanning substrates using information (analog or digitally) encoded. The read/write devices can be remote and operate separately or can be attached to existing communications devices and products.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The system provides for direct hand-held portability, finger tip attachment, hand-held device attachment, palm carrying, segmented or detached geometries, highly miniaturized or micro-etched or machined elements, biologically or physiologically interfaced configurations, implanted configurations and any practical form which provides for direct writing, printing or encoding, as well as direct or indirect digital or analog information receiving capabilities. Direct remote digital printing units can be attached to or used with cellular telephones, digital electronic devices, note book computers, toys, automobiles, palm size computers, wrist watches, global positioning units, digital cameras, digital video recorders, digital voice recorders, radios, digital music players, desk top computers, appliances, DVD players, various electric devices, remote military field devices, airplane phone systems, pagers, logistics recording units, field monitoring equipment, medical recording equipment, ultrasound equipment, video arcade games, Blackberry™ devices, Palm Pilots™ PDA devices, Blackberry™ PDA devices Symbol™ devices, UPS™ electronic note pads or the like.

More specifically, the system can receive information remotely and either via analog or digitally (wirelessly) or directly scan encoded information embedded in a substrate optically, magnetically, thermally, mechanically, radiatively, micro-electronically, conductively, piezo electrically chemically or the like. The encoded information can subsequently be processed and used to designate parameters used in the subsequent printing process. The information received can be analog signals, voice, voice-over ID, parallel, serial, radio wave, high frequency, optically-encoded through broad band, electronically broad band encoded, compressed or non-compressed digitally, in written or printed, typed or graphically displayed, character recognized, bar-coded, embossed, encapsulated, sequential or non-sequential, illuminated or non-illuminated, embedded, security encoded, holographically encoded, biologically encoded, encoded with plural means such as partially optically partially magnetically encoded or partially encoded by at least 2 means or as many as 20. More typically encoded at least 2 to 10 means and more typically encoded at least 2 to 5 means. The encoded information can be continuous or segmented and regionally encoded, parallel, sectored or non-sequential.

The system has or can have digital alphanumeric, serial or combinations of processing and micro processing capabilities. The processors can be directly or indirectly associated with the receiving (reading) components and the writing (printing) components. Processing can be embedded in integrated circuits, encoded in recognition software, a part of an operating system or remote to the device. Neural interfaces can take advantage of galvanometric impulses.

Artificial intelligence and neural processing can be utilized to assist in the processing of data either read or written. Various interfaces with central processing units can be utilized to assist in data transfer, wireless communication, improve data processing speeds, encryption, access files relevant to the printing process, down load files to be printed, and receive real time information intended for printing.

Various software programs can be utilized for voice recognition, character recognition, broadband digital and analog information received for processing encoded and decoded information and the like. Software and programs can be contained within the device or operated remotely and sent to the device after part or all of the processing is complete.

Processing capabilities of the system can be directly or indirectly interfaced with various system components. Information, which has been received or is being continually received throughout processing, reading or writing, storage, latency or post processing, can be used in conjunction with the intended read/write mode of the system. For example, while digitally writing, updates can be made during text messaging printing or information quarried can be co-processed and revealed. Processing can take place from information received from the writing/printed medium or substrate alone or together with information received remotely.

Further information can be received directly or remotely from sensors or monitors interfacing with the system. For example, body temperature can be monitored and reported during a medical diagnostic analysis and the information directly processed in parallel with other digital or analog information received about the patient. Simultaneous processing and reporting, writing or printing parallel inputs provides for a convenient means of providing immediate useful information to a user or participant.

Encoded time, positioning global positioning, page or substrate positioning or other relevant logistics information can also be recorded. Sensing data including ambient environmental information, in vivo physiologic information (e.g. cardiac information), patient data regarding statistics or diagnostic, industrial information manufacturing and production information, diagnostic automotive or appliance information, communications and military information, travel and flight information intelligence information, academic information, client or customer ordering information, travel information, legal information, political information, news, data, results of tests and assorted other real time or factual information can be received either remotely or sensed directly using appropriate monitoring and information gathering means.

Information inputted into the system can be processed serially or in parallel such that it can be subsequently decoded, analyzed and reported during use of the system or stored for later evaluation.

After inputted information receipt and processing the information data or resulting product can be subsequently outputted and written or printed directly to a substrate. The output can be either analog or digital. The output can be directed to the substrate directly through various information transfer means. Output can be written or printed using thermal, optical magnetic, geometric, chemical liquid, fluidic, tactile, colorimetric, inked, jetted, ink jetted, energy frequency encoded, encoded with piezo electronic elements, Peltier elements, lasers, LED's physically imprinted impact imprinted, holographically printed, piezoelectric actuated embossing, embossed at ultrahigh resolution using cantilever tips and components now commonly used for atomic force microscopy, substrate released where the substrate respond specifically to an input from the output device such as thermal relief from a thermal print hand or chemical recognition form a pertinent stimuli and the like.

The output can be a parallel or serial information packet, which is revealed and obvious or encoded or encrypted and not obvious. The output can be simple lines, graphics, pictures, text, bar-codes, figures, relief structures, revealed messages, printed messages, various fonts, parallel processed readable as well as encoded information, single colored or multiple colored, various hues generated by a combination of the output mode and the substrate algorithms based upon multiple input data or sensors, formulas, advertising information, coupon information, UPC codes, cartoons. Educational text or logistics information during shipping, packaging information, receipts, streaming data, compressed data, various software files for word processing, spread sheets, data base software, medical patients stats, musical notes generated while composing a song, meter reading information, traffic citation information, sweepstakes information, sales and marketing information, cosmetics and skin care alterations to skin as a substrate, medical skin care and dermal care applications, domestic and wild animal tagging, laboratory to animal marking and reporting, sports scores and statistics, notes, documents, voice recognized processed and outputted texts, audio to visual information, digitally recorded processed and printed pictures, graphics and text, regenerating printed information on regenerating read/write substrates, optical fluorescence, recordings, embedded chemical signals, embedded security information, currency validation marks, map information, direct to foods printing, restaurant information such as orders from customers, messages to personal, food validation, inventories and the like, airline scheduling, ticketing and security information, postal and carrier information for stamps, postage rates pick-up delivery and tracking numbers, meat, poultry and perishable direct and label printing to encode dates and lifetime, updated product expiration dates, security encoded information such as finger prints, forensics information from the field such as military coordinates and order information shared between parents and children, teaching aids and products to help and assist students, lecture note taking and assisted learning where multimedia inputs can be selectively outputted or the like.

Digital recordings which can be later scanned, processed and utilized, tracings, encrypted messages which can be processed and unencrypted for output, outputs which are synergistic with reading information and writing depending on the subtext desired by an author, fast food printouts, personalized labels text, business cards, instant flash cards derived from informational teaching, removable printed labels for garments or laundry services, home schooling information to augment learning, revealed or induced relief structures for the usually impaired (e.g. Braille or contoured images), 3 dimensional structures to be utilized for further information processing, 15 Ames such as direct printout form products like Sony Game Boy™, Ohio Art Etch-a-Sketch™, digital printouts from learning devices such as Leap Frog™ learning devices, Lyric printouts from digital recordings, messages from news agencies, printed graphics associated with tests or learning courses, national identification information printouts and the like.

Underlying text and graphics can be revealed from the substrate being printed onto. For example, paper substrates can be pre-printed with information, text graphics or the like either obscured visually or partially revealed whereby subsequent information output printing causes an instant apparent image change to a different format from the first.

Examples include games or educational learning devices used by children or adults. Direct output can be accomplished onto substrates such as thermally active papers, plastics, foils, woods, metals or other flat or contoured surfaces including skin. The output can be analog such as a single continuous heating element, parallel such as a high resolution print head, massively parallel such as side-by-side adjacent parallel print heads or the like.

The output/print can be monochromic or polychromatic various color or color changes can be induced in the active matrix of the substrate. The substrate to be written on can be flat and planar, curved and contoured, flexible or rigid, dry or moist, rough or smooth, in a fixed two-dimension or a fixed 3-dimensional form for contour printing and printing relief structures. The substrate can be a fabric, paper or other conventional printable surface.

The output process can induce non-geometrical visual changes or topological changes in the substrate. For example, the substrate can be a simple piece of paper pre-printed with a thermochromic ink whereby the thermal print head contacting the substrate during use causes local color changes and patterns dictated by the user and device. The resulting output can be an art design or printout on thermal paper.

In another example, the substrate can contain a thermally responsive material, which changes shape or transiently melts as the thermal print head traverses the substrate. Single and multiple effects can be achieved in the thermally tactile substrate whereby either the substrate simply conforms to the contact of a heating element and a relief structure is produced or the substrate can possess a pluralistic response whereby the substrate can simultaneously change color locally and conform to reveal a relief structure. Reversible color changes as well as irreversible color changes can be applied. Likewise reversible and irreversible relief structures can be formed.

For example, a substrate can be formed which contains both a thermal switching or melting medium, which can be locally melted with the output element. The medium can also contain a reversible thermochromic agent that changes from one color to a second, when the output-heating element locally traverses the substrate. The substrate can be constructed such that the output element is either directly or indirectly in contact with the thermally responsive medium. During use, the thermal output element moves across the substrate/thermal medium. Color-shifting melted lines occur where the element contacts the substrate directly. The thermal switching/melting component of the medium/substrate can have a melting transition such that the removal of the heating output element instantly results in the formation of a printed relief structure. The thermochromic color-changing component likewise can be a transient color change that will remain one color when in contact with the element, but will revert or reverse back to its original color when the heating element is removed or displaced. Due to the reversible melting properties of the thermal switching medium the physical relief structure written or encoded in the substrate can be melted and smoothed to bring the substrate back to its original configuration. Such thermally responsive substrates can come in a variety of thicknesses, shapes and sizes.

Thermally responsive substrates can be coated such as coated papers, impregnated substrates, encapsulated dyes on substrates which can have melting waxes which expose underlying dyes or can be laminated with various optically, thermally, magnetically, chemically, physically, or biologically responsive layers or components. Colorimetric product producing enzymes or catalysts can for example be embedded in the substrate. Heat activation or deactivation can be used as a means for inducing a color-shift in a medium to be printed.

Substrates suitable for applying a representative printing medium can include various paper stocks, coated papers, plastics, metals, foils, rubbers, composites, wood and other cellulose based materials, natural surfaces, surfaces of living vegetation and leaves, the surface of produce, glass, painted surfaces, photographic film, Mylar, holographic surfaces, currency surfaces such as paper money, nylon mesh, nylon fabrics, textiles surfaces, medical adhesives, adhesive and glue surfaces, chip board, card board, meat and dairy products, cartons, packaging materials, wire coatings, post printed materials, inks, photo resist materials, photographic paper, ink jet printing paper, tags on meat and dairy products, semi-permeable substrates for permeation alteration, shrink wrap materials, materials which change shape in response to heating, heat activated shape changing materials, mirrored surfaces, alloys, balloons, toys, liquid crystal displays, liquid crystal materials, wax, vapor deposited surfaces, news paper, magazines, books, sublimed dyes, hot stamped surfaces, Indigo™ printed substrate and surfaces, store tags and security tags, and commonly used thermal papers for offices vending machines, labels receipts and the like. Likewise, printable substrates can incorporate an active matrix such or OLED substrates, electro-active polymers, heat activated or deactivate biologic materials such as enzymes and heat shock proteins, thermochromic polymers, organic substrates, and inorganic substrates.

Of particular importance are printable substrates, which can be conveniently printed with using a printing medium appropriate for a particular direct digital printing process to be employed. Substrates to be considered should adequately display the ink, agent, or medium to be digitally printed. Likewise, substrates should be compatible with the application process for applying the direct digital printing medium.

Often it will be desirable to utilize common printing stock materials such as papers, pressure sensitive labels, films, and the like typically used for high speed process used for coating printable substrates. In addition, for high volume applications of direct digital printing processes it will be desirable to utilize printing and coating process commonly used for coating stock printable substrate. For example, for printing paper stock with a color-shift agent to be used in a direct digital printing application, it is desirable to use a compatible printing process such as ink jet printing, flexographic printing, screen printing, off-set printing, drum printing, spray coating, Gravier printing, Indigo™ printing, flood printing, vapor deposition printing, or the like.

The color-shift material can be applied directly or in combination with a printing matrix, ink or resin. The color-shift agent will be applied in a pure form from an evaporative solvent such as acetone, methyl-ethyl-ketone, ethanol, isopropanol, or the like. In case the color-shift material is applied in combination with a printing matrix, ink or resin, the material is can be typically added at a concentration from 0.1% by weight to 99% by weight. Usually, the material is added from between 0.5% to 50% and most often from between 1% to 10% by weight.

The color-shift material can be printed in an inactive form and then activated after the coating process has occurred or activated prior to the substrate coating process. The activation state will depend on the intended direct digital printing application of interest. For example, for direct thermal printing processes, thermochromic color-shift material should be coated on to a substrate such that the activity is retained during the printing process and yet activated to that it is ready to be directly printed.

Standard Etch-A-Sketch can be modified such that the stylus and movement elements can be utilized for x, y plotting. The stylus can be adapted with various elements such as a heating element which has a thermal capacity and conductivity necessary to cause a color or tactile change in substrate (planar) applied to the visual plate. Color changes or color-shifting substrates employed can exhibit single or multiple color transitions, expose one or more colors, reveal messages, have different initial and final colors depending on the specific areas of application, reveal different under laying colors or the like. Color shifting mechanisms can include reversible or irreversible color changes, single or multiple colors, be formed in a digital or analog printing format, use high or low temperature transitioning color-shifting dyes, use transient or permanent printing mechanisms, use read only or read/write substrates or the like.

Papers and plastic printed with thermochromic agents can be applied to the planar plastic or glass substrate such that there would be thermal contact between the substrate paper and heating element. As the heating element was adjusted to a temperature about the colorimetric thermochromic change of the thermochromic agency, the color changed from an initial color to a second color permanently and irreversibly.

Various thermochromic (intrinsic) and thermally sensitive agents were utilized. For example, polymerized reversible and thermochromically irreversible polydiacetylenic compounds were printed onto a paper, plastic, glass, foil or other substrate and attached or placed against a stable planar plastic or glass transparency or plastic. S the hearted stylus was moved and heated (to above the thermal transition of the polydiacetylenic coating) the Dark blue paper or substrate revealed a brightly colored (red, orange, blue) line where the stylus/heating element was moved. Lines, dots and various features were formed. The color change was instant or slowed depending on the temperature setting. Additional colors and information were printed below the polydiacetylene layer to reveal various colors and effects. The product provides an interactive system for art, games, business and educational purposes.

Various color-shifting agents and thermally responsive materials were printed and used in the device. Liquid crystals, melting waxes, commercially available thermal printer paper, polythiophene compounds, electro-optical polymers, conformational state change polymers, top( )-chemical polymers, intrinsic color-shifting polymers, charge transfer complexes, dye sublimation compounds, charge transfer dyes, azodyes, azodye-polydiacetylene compositions, stilbene compounds, photochromic dyes, mechanochromic dyes, thermal inks, encapsulated thermal dyes, conventional thermochromic agents, spiropyran leuco dyes, leuco quinine dyes, thiazine, oxazine, and phenazine leuco dyes phthalide-type, color formers leuco triarylmethanes, and fluoran leuco dyes and the like were can be used as one or more elements of a remote digital printing medium.

Standard commercial thermal print papers can be employed as printable substrates using direct digital and analog printing devices. The advantages of various printing options made possible by different print head option of direct digital printing devices can be applied to conventional thermal printing mediums and papers. Commercially available thermal paper suppliers/manufactures include: Appleton (USA), Jujo (Ahlstrom, Finland), Kaman (Germany), Mark-sensing (Australia), Merley (USA), Mitsubishi (Japan), Oji Paper (Japan), Nippon Paper Industries (Japan), Redstone (Taiwan), Richo (France), Shingsong Paper Tech Industries (Korea) as well as other US and foreign companies.

Printable papers can also include standard white or colored papers where thermal printing is accomplished by thermal transfer of a dye from a thermal transfer ribbon or tape to the paper. The thermal transfer ribbon or tape can be positioned between a thermal print head and the paper. Registration between the ribbon or tape and the paper can be accomplished using a roller or dispenser mechanism so that the ribbon or tape is released at the same velocity as the travel speed along the paper being printed. The ribbon or tape should be sized accordingly with the thermal print head.

Combinations of color-shifting agents alone or together with common thermal printing paper and substrates can be used in a layer form together to produce multiple color out puts. For example, a blue polydiacetylenic coating can be placed over a white color encapsulated green thermal print paper. The thermal transition of the polydiacetylenic material can be set such that a low thermal print temperature can be used to turn the blue polydiacetylenic material to the polymer's red form. The thermal transition of the underlying encapsulated green thermal print paper can be set at an optimally higher temperature such that only a high thermal print setting will expose the underlying green dye. The combination of a three color potential revealing blue, green, and red, provides for a RGB color output standard in printing. Direct digital color printing can be accomplished by using a two temperature direct thermal print head which can activate a lower temperature first color change or a higher temperature second color change. Other color combinations are made possible using different permutations of colors or layers of colors. Likewise, polydiacetylenic dyes can be used alone or in combination with other stationary dyes to achieve different initial colors prior Lo temperature triggering as well as various color hues after temperature triggering.

Thermal print paper employing encapsulated or coated dyes can be formulated with different colors of encapsulated dyes as well as different colors of overlaying encapsulating materials too hide the encapsulated dyes. Various encapsulated colors can be employed including red, green, blue, black, orange, magenta, tan, yellow, as well as a full spectrum of standard Panton™ and PMS colors.

Single or multiple color changes can be induced using a direct remote digital printing algorithm. Reversible color-shifting mediums can be employed where by only printed regions of a substrate remain thermochromically reversible while the printed region becomes irreversibly color-shifted to a stationary color. Subsequent mild heating or cooling of the entire substrate can serve to enhance or diminish the contrast of the printed region compared with the unprinted thermochromically active region.

Direct digital printing can be used conversely to inactivate a color-shift medium print coated on a substrate. For example, a thermal print head can be scanned over a surface with an inactive monomeric form of a diacetylenic compound. Unrecognizable printed patterns can be formed whereby the printed regions disrupt the monomeric compound's ability to be polymerized. After printing, when the substrate is exposed to ultraviolet light, the printed region will stay uncolored whereas the imprinted region becomes colorized to create a negative print image.

Various thermal and optical print heads can be utilized in various device configurations. For example, parallel print heads removed from thermal printers such the Brother-P-Touch™ label printer and the Brother Thermal fax printers can used by attaching the print heads to a stylus. Thermal print heads from any of a variety of manufactures, subsystem assemblers, OEM manufactures, component suppliers, or any other relevant supplier can be utilized.

Print heads can also be applied to small fingertip sized carriers such that the print head could be attached to a fingertip. This configuration permits direct fingertip printing whereby the stylus or movement element is a finger and has the fidelity and coordination of fingertip movement over a substrate to be printed on.

In one example, the thermal print head from a Brother-P-Touch™ was removed from the product and utilized by attachment to a fingertip holder. A micro-processor, power source and support electronics were assembled to include, a key pad and display screen. Messages were inputted into the device and printing was initiated. As the thermal print head was contacted with a paper containing a thermochromic agent, wording, graphics, text, text messaging and information was printed directly from the finger to printer onto the thermochromic paper.

Voice recognition components can be interfaced with the portable print unit such that voice could be directly recognized and printed out by the unit. Voice recognition subcomponents to a remote digital printing process find a multitude of uses where voice commands and voice recording can be instantly digitized, transformed, and digitally printed in sequence with using the printing device. For example, a waiter or waitress could simultaneously take a customer order and digitally transcribe it on to a color-shift substrate. Alternatively, a student could record lecture notes during a class with precision and accuracy. Computational elements with in the device could assist in the educational processes by adding notations or other information pertinent to the lecture.

In another example, an optical printer was made using an ultra violet light source (254 nm). The light sources were handheld using a battery pack for power. Conventional UV sources from Cole Farmer and SteriPen™ were adapted with lenses such that pin hold collimated light was produced. The optical print head was moved over a photochromic substrate to create optical images, text and graphics. The line width could be adjusted based upon the distance the optical pen was placed with respect to the optically responsive substrate.

By way of example, the optical print head can be mounted on a stylus and moved by mechanical means to create optical images. In another example, a handheld optical pen was used like a handwriting implement such as an ink pen or pencil to create optical text, lines and graphics.

Depending on the light source, the optical print head can be analog or digital. The optical impulse can be serial or parallel in output. Multi-optical light sources can be complied for parallel digital printing. Miniaturized optical heads provide for fingertip optical printers and remote digital printing products.

Likewise optical and thermal print heads can have geometries which provide for x and y printing. Print heads can be parallel in arrays and be arranged from a single pixel print head to massive parallel x, y configuration. Print heads can arrange from single pixels to lines of print elements arranged linearly. Print heads can have an x, y configuration such as x, across a diamond shape, a square or a filled square with a filled pattern. The number of discrete print heads can range from a single head to mega pixel arrays with 10,000 print heads in the x direction to 10,000 miniaturized print heads in the y direction. In certain embodiments 1,000 print heads are arranged both in the x and y configuration and more typically, 100 print heads are arranged in the x and y directions.

Print heads can be produced on either flexible or rigid supports. Print heads can have a planar configuration or a geometric shape, which enables the print head to favorably interact with a substrate or surface containing an agent that responds to the printing mechanism.

For example, the print head can be a linear array of thermal print heating elements. The linear array can be placed at the end of a rigid strip. A one centimeter linear thermal print head containing side-by-side 100 micron print heads can contain 100 discrete parallel print heads. The heads can be produced using standard flex printing and etching process. The print head array can be conveniently placed on the end of a stiff or flexible substrate such that the linear array is at the end and in parallel with the end of the substrate strip. The configuration provides for maximal contact between the thermal print head array and a surface containing a thermally responsive agent.

Parallel x, y print head arrays have the advantage of immediate horizontal and vertical transverse printing. For example, a 100 pixel x axis by 100 pixel y thermal print head array can be utilized in combination with directional printing and positioning encoders to allow complete flexible movement of the print head in the x direction (from left to right) over a page, in the y direction over the page or diagonally in both directions simultaneously across the page.

X, y print head geometries combined with the facile movements of fingertips provide for unique printing applications and effects, a single linear x array print head can be traversals sideways and simultaneously be move x, y and x, y− to create movable optical print effects, words, messages, graphic can be distorted and manipulated during the printing step. Line, waved graphics, circled text, curves x/y step functions and the like can be generated. More complex motion or sequence of motions can be created. By way of example initially an x only motion can be started follow by a y only motion. Subsequently, x+ y+, x+ y−, x− y+, x− y−, x0 y+, x+y0 and a variety of other motions in a linear or step and repeat form can be used to create novel images and graphics or real time graphic displays or art shows.

Large two-dimensional print head arrays can be produced where the print head array may be in stationary contact with a printable medium. As digital commands can be sent to the print head array such that two-dimensional image can be formed without moving the print head array over the medium surface. Large two-dimensional print head arrays can be used for instant bar code formation, stamping digital messages, creating multiple sequential outputs on-demand and generally for tasks where only a single instant contact between the print head array and the printable substrate is required.

Flexible compliant digital print heads can be utilized to topologically comply with a non-planar surface. For example, a flexible print head can have a linear thermal print head array mounted on a flex circuit. The mounted head/flex circuit connector can be adhered to a thermally insulating substrate, which is also flexible and compliant. Compliant substrates can include rubbers, silicon rubbers, room temperature vulcanizing compounds, leather, composites, fabrics or any suitably durable insulating material. Flexible/compliant print heads can have ranges of flexibility in the x, y and z directions depending on the application of interest and substrate intended to be printed. For highly non-planar surfaces it may be desired to have a suitably flexible print head. For rigid surfaces, it may be desirable to utilize a less flexible print head. Print heads may be designed to control the level of flexibility and conformational distortion anticipated for a particular application.

Electronic actuators such a piezoelectric actuators and be integrated into a flexible printing head configuration so that the conformation of the print head can be precisely controlled through an encoding process. Print heads may also be self-mobile using the actuator means to transducer a positional change for the print head during the printing process. For example, a thermal, optical, or alternative print head device could be capable of traversing a medium to be printed automatically and remotely without any physical influence from the user.

In one design, a miniaturized robotic printer could be configured such that the remote digital print head is moved by a computer controlled servo or stepper motor device. The robotic motion and digital printing process can be programmed to work in unison such that a desired printed out put can be achieved without physical intervention. Movements in x, y, and z could be controlled to comply with variation in surface profiles to be printed.

Micro-robotic direct digital printing devices, which can function remotely or autonomously, can be programmed to find a home position prior to initiating the printing process. Likewise, once printing is complete, the device can be programmed to resume a desired position. For example, a small desktop unit can be designed to locate a paper edge. Once located, the printer could initiate a preprogrammed print sequence. Once printing is complete, the device can be programmed to find its original home position. Printing sequences can be preprogrammed or be established in real time through a wireless communication to the printing device. Autonomous direct digital printing devices can have the advantage of operating in hostile or confined environments. For example, a small unit can be designed to function in a narrow space on a surface that can not be accessed by an individual. The device can be place on a surface to be printed and subsequently print a desired output. After printing, the device can be programmed to resume its original position and be retrieved.

In general, additional functions can be incorporated into a direct digital printing device beyond the singular function of printing alone. For example, cutting elements, scoring elements, marking elements, optical scanners or readers, positional encoding elements, miniaturized cameras integrating direct feedback to the central processing unit, sensors, biosensors, chemical sensors, and other functional elements can be integrated to work in conjunction with the direct digital print system.

In additional representative embodiments, the computer mouse/printer devices are provided. A combination computer mouse/printer has the unique capability of controlling actions of the CPU as well as directly printing and feeding back information from the CPU. The manual analog motions of the mouse/printer control the position of a print head integrated into the mouse/printer structure. The motion control for cursor movement is similar to the fidelity required for manual driven print motion. The immediate, facile, and direct means for information input and information output provided a unique and unprecedented means for information transfer interface between an individual and computer.

Various connection scenarios are possible. The mouse/printer can be connected in parallel or through a series CPU port. A variety of connection options are feasible including RS 232, IEEE buses, Firewire™, USB™, or the like. Likewise, wireless infrared, radio, or other spectral remote signaling can also be utilized. It is important that the connection be both able to send and receive signals.

Logistics of the cursor movement and printing output can be coordinated. By way of example, cursor movement utilized in a word processing program can be utilized for high-lighting words or text. Signaling mechanisms in the mouse/printer combination can be utilized to both establish a printer link and directly print out the high-lighted text. Positioning sensing for cursor movement and printing initiation can be independent or coupled. Utilizing the same sensing mechanism has the advantage of consolidating uses and therefore simplifying device as well as keeping component and manufacturing costs lower than if separate components were to be required.

Print driver software can be located either internally in the mouse/printer or in the intended CPU. Mechanisms for printing activation can likewise be software actuated utilizing icon mechanisms projected on the computer screen or switching mechanisms comprised by the mouse/printer device. Control features on the mouse/printer can be programmed through software to coordinate print signaling activation and characteristics.

Conveniently, a cursor mouse pad can serve as a compliant surface for improving the interaction between a print head and the paper for intended printing. Simultaneous cursor movement and positing can benefit from motion control on a uniform surface such as a mouse movement pad. Likewise, mechanisms can also be designed and improved that do not require the use a mouse pad.

Printing technologies utilized in a mouse/printer can include thermal print heads for printing on thermal papers, ink jet print heads along with ink reservoirs for printing on conventional paper, dye sublimation print heads printing on standard acceptable paper, miniature optical print heads that optically induce a printed response in optically responsive paper and the like.

Digital and analog versions of direct printing devices can be designed for various anatomical fittings on fingers, palms, limbs, and or prosthetic devices used for disabled individuals. Where cosmetic skin alteration is desired, a precise anatomical fitting on a fingertip or hand would be desired. Where the device is used for a disabled individual, attachment of the printer to a prosthetic device such as and artificial limb may be desired. For graphic artists, graphic designers, or other related professionals, it may be desirable to equip the direct digital printer to a hand or side arm such that natural motions normally to utilized by the professional could be accomplished during the printing process.

Alternative substrates and applications are made possible using remote digital printing process and compliant print heads and surfaces. For example, skin can be directly cosmetically altered with digital resolution and fidelity. Direct digital printing on skin make possible a variety of new cosmetic and medical applications for skin care. Skin alterations can be accomplished using direct digital skin printing process. The thermal printing impact on outer skin layers can be used to tighten, realign, stretch, de-pigment, re-pigment, re-texture, smooth, cosmetically alter, temporarily alter, permanently alter, morphologically change, or medically heal. Skin cancerous regions for example can be digitally augmented to assist in a healing process. Topical applicants can be thermally or optically fused directly at the skin level to accomplish certain medical treatments. Skin can be cosmetically grafted to overcome unwanted birthmarks or permanent skin blemishes. Alternatives to current surgical facelifts can be accomplished using digital skin augmenting processes.

Digital patterning can be delineated for specific skin types and desired skin alterations. High resolution skin alteration processes make possible desired visual, changes such that dot patterns, digital patters, lines or other markings can not be visually interpreted and look normal to a viewer.

Digital skin alterations can be further augmented by pre and post skin treatments. For example, prior to digital skin printing and alteration, the area to be influenced by first changing the skin temperature. Skin temperature can be initially warmed above body temperatures to 90 to 100 degrees F. or chilled below body temperatures to 40 to 60 degrees F. Temperature can be used to effect how the digital printing process impacts the skin. Temperatures above body temperatures will increase blood flow and slightly swell skin prior to printing whereas temperatures below bodily temperatures will shrink skin prior to printing.

Alternatively, local topical agents can be applied to the skin area to be augmented. Topical treatments can included analgesics, moisturizers, tightening creams, stimulating creams, dermal treatments, cleansing creams, alcohol and other drying solvents, natural oils, long chain alcohols, and any of a number of treatments which may have a synergy with the digital skin printing process.

Direct remote analog/digital printing devices can find use with selective thermal coatings. Coatings can be placed on printable substrates such that over printing/digital thermal treatment can be used to selectively fuse the coating to the substrate. The selective fusion process can be used to seal the substrate in pre-designated patterns. The process can be used to create digital designs, patterns, or features on surfaces that may subsequently be used for selective permeability, solubility, dissolve away characteristics, or the like.

Features of various embodiments of the invention include one or more of the following: the printer is not fixed in x, y, or z and therefore provides a full range of motion for creating unique effects; unlike conventional printers, motion and printing are decoupled (such that the printhead in representative embodiments is free of any mechanized controller, and yet still prints on a substrate in a controllable fashion to produce a printed product, e.g., text or design, etc., according to a predetermined instruction); hand motion or indirect motion can be used to move the print head over any substrate including contoured surfaces that can not be printed using conventional means; the system provides for significant degrees for freedom and interactivity to create unusual and unanticipated effects; motion of the print head is analog whereas the printing process is primarily digital so that the effects can be self directed and on-demand; the system eliminates the need for the printer to have moving parts thereby simplifying construction and reducing cost; the system provide an on-demand capability to augment graphics from software outputs immediately requiring no further digital processing; compliant print heads provide for significant latitude in printing on irregular surfaces; and the system provides compatibility of a wide variety of digital outputs intended to be printed.

The following examples are offered by way of illustration and not by way of any intended limitation.

### EXAMPLES

### Example

### Print Coated Color-Shift Paper Mediums

Standard 8.5 by 11 inch sheets of paper ranging in color including white, yellow, pink, orange, red, light green, light blue, magenta, tan, off-white, as well as papers with pattern designs were printed with polydiacetylene as the color-shifting agent. A solvent based solution containing 200 mg/ml 10, 12 tricosadiynoic acid (GFS Chemicals) and 20 mg/ml 10, 12 pentacosadiynoic acid (GFS Chemicals) was prepared using a mixture of ethanol (USP/NF grade) and chloroform at a 9 to 1 ratio volume to volume. The solution was filtered through a gravity filter (Whatman 541).

Paper sheets were print coated using ink jet printing, spay coating, or flexographic printing. For flexographic printing, diacetylenic monomers were combined with a standard resin based printing matrix to achieve good adherence to paper stock.

After print coating the diaectylenic monomer compositions on paper sheets, the diacetylenic monomer coatings were activated and converted to the blue colored polydiacetylenic polymer by exposure to ultraviolet light (254 nanometers). Various blue hues were achieved by using low intensity irradiation for light blue hues and high intensity for dark blue hues.

Color-shift print coated papers were used for a variety of direct digital and analog printing applications. Plain print coated papers where the blue polydiacetylenic coating was printed on white paper were used for creating red printed outputs. Yellow paper stock coated with the blue polymer provided a green hue prior to the thermochromic change and an orange hue after the change. Orange paper stock appeared brown when coated with the blue polydiacetylenic layer and converted to a golden yellow when thermochromically color-shifted during heating. Light blue paper stock appeared dark blue after coating with the polydiacetylenic layer and appeared purple magenta upon temperature triggering. Pre-printed graphics could be hidden or obscured by the polydiacetylenic layer and revealed when the color-shift agent thermochiomically triggered.

### Example

### Analog Color-Shifting Sketching Device and Printing Medium

A device for sketching optical color-shift lines, graphics, pictures, text and other visual formats was constructed using the body and mechanism of an Etch-A-Sketch toy (Ohio Arts Company). The toy was modified such that the x, y positioning elements could be used to carry a heating element. A heating element was constructed using a modified soldering gun (Weller Company). The heating element from the soldering gun was removed and attached to the x, y stylus of the sketching toy. The toy body was modified such that the electrical cord attached to the soldering gun exited the base of the sketching toy. The heating element cord was looped in order to avoid any constriction of motion of the x, y positioning stylus and elements of the sketching toy. The sketching toy top window was converted from a glass plate to a clear high impact plastic. The top plastic plate was designed for easy fitting into the available slot on the sketching toy. The fitted plastic plate was used for attaching and inserting individual paper sheets the same dimension of the plastic plate (6 inch by 8 inch). Individual printed paper sheets were printed on one side (see example: Printed color-shift paper mediums).

Print coated paper sheets, containing a color-shift printed medium, or standard thermal printing papers were placed in the sketching device such that the colored side was face up and in contact with the clear plastic plate. The device was powered using a battery pack attached to a power plug and an on/off switch. To operate, the printed paper sheet and plastic plate were installed. The device was activated and the heating element warmed.

The heating element was modulated to maintain a temperature necessary to cause a color change in the dye used on the printed paper medium (complete color change at 250 degrees F., element maintained at 300 degrees F.).

Color-shift and change lines were drawn directly on the printed paper medium as the heating element stylus was moved across the surface of the sheet. Lines were made thin by rapid movement and thick by slow movement and more intense heating. Lines and dots were created by rapidly hopping the stylus from one position to the next. Various patterns and graphic displays were created using the x, y elements. The heating element head was further modified to accept various geometrically shaped heating tips. The geometrically shaped tips were used to create various patterns and color-shift lines in the printed medium. For example, a side-by-side tip was made to create parallel line patterns. Elongated and beveled tips were created for making wide lines in one direction of movement and thin lines in another direction of movement. Single drawings were created replacing different shaped tips during the process of drawing.

Various color-shifted graphics and line art were created using papers with different background colors and varying amounts of color-shifting agents coated on the paper substrates. Pre-patterned/colored papers were coated with color-shift agents to achieve patterned effects when the color change was induced.

### Example

### Remote Digital Finger Tip Printer Device

A hand-held label printer (Brother P-Touch Home & Hobby™) was modified from its original form of a label printer to become a fingertip printing device. All of the internal mechanical parts were removed and disconnected. The thermal print head was dismounted and transformed so that the print head was free with a full range of motion. The thermal print head was mechanically machined so that the heating element strip became a small 0.5 by 0.75 pad. The thermal print head was kept connected to the original printer with the attached connector cable strip. The back of the thermal print head pad was adapted with an adhesive strip for mounting reversibly on a fingertip. The print head pad and connector cable were diverted out side the housing of the original printer such that the print head pad had a range of motion consistent with the length of the connector cable (2 inch range). Thermal print head was maintained with full operability from the keypad on the original label printer housing.

For operation, a message could be typed in on the keypad of the original label printer housing. The housing was held by hand in a position that kept one finger free for mounting the adhesive backed thermal print head to one finger. The digital finger tip printer configuration complete 3-dimensional motion of the full device and provided for complete dexterity of use of finger movement of the print head attached to the finger tip. For printing, after a phrase had been typed into the device from the keyboard, printing was initiated by pressing the print button on the device. The phrased was written with a brief delay sequence to provide for a 2 second delay prior to initiating the print sequence. The fingertip digital print head was placed in immediate contact with the surfaced of a color-shift print paper. An x, y motion was initiated across the print paper surface. The typed in phrase was printed exactly in sequence as was logged into the device. Digital fingertip printing was accomplished using several different x, y sequence motions. Wording could be printed linearly or non-linearly. Phrases could be made straight or waved. Lettering could be compressed or expanded depending on the rate of motion applied to the thermal print head as it traversed the color-shift print paper.

### Example

### Self-Printing Book with Attached Digital Pen Printing Stylus and Thermally Printable Pages

A hand-held label printer (Brother P-Touch Home & Hobby™) was modified from its original form of a label printer to become a self-printing book device as described above. All of the internal mechanical parts were removed and disconnected. The thermal print head was dismounted and transformed so that the print head was free with a full range of motion. The thermal print head was mechanically machined so that the heating element strip became a small 0.5 by 0.75 pad. The thermal print head was kept connected to the original printer with the attached connector cable strip. The print head was mounted on a plastic pen length stylus. The print head was angled at 30 degrees with respect to the pen length body. This angle was optimal for inducing contact between the thermal print array and a printable substrate.

The print head pad and connector cable were diverted out side the housing of the original printer and the printer cable was extended such that the digital printing stylus had a range of motion consistent with the length the connector cable (10 inch range). Thermal print head was maintained with full operability from the keypad on the original label printer housing. The digital pen printing stylus had a full range of motion such that any given page within an attached book could be addressed and reached within the book.

For operation, a message could be typed in on the keypad of the original label printer housing. The printer housing was mounted within a 10 inch 3 leaf 3 ring binder. The digital pen stylus printer configuration complete 3-dimensional motion of the full device and provided for complete dexterity of use of the stylus as easily as any writing pen. For printing, after a phrase had been typed into the device from the keyboard, printing was initiated by pressing the print button on the device body mounted in the book. The phrased was written with a brief delay sequence to provide for a 2 second delay prior to initiating the print sequence. The digital print head was placed in immediate contact with the surfaced of a color-shift print paper. An x, y motion was initiated across the print paper surface using the stylus pen like a normal pen or pencil.

Sheets of thermal paper were hole punched and inserted into the 3 ring binders of the book such that the printer and stylus was mounted on the opposite side of the book relative to the paper pages to be printed in the book. A typed in phrase was printed exactly in sequence as was logged into the device. Digital printing was accomplished using several different x, y sequence motions. Wording could be printed linearly or non-linearly. Phrases could be made straight or waved. Lettering could be compressed or expanded depending on the rate of motion applied to the thermal print head as it traversed the color-shift print paper.

### Example

### Integrated Remote Digital Printer Attached to and Used with a Cellular Telephone

A remote digital printer was adapted to a cellular telephone such that the printer was attached directly to the base of a cellular phone. The phone/printer became one unit where messages and outputs could be directly printed from the cell phone by simply moving the base of the phone/printer by hand over a printable paper substrate. Hand motion along with contact at the base of the printer lead to clearly printed messages down loaded from the phone.

The printer was connected to a parallel output from the telephone. The printer was powered with its own battery source independent of the telephone battery. The keypad from the telephone was used to input text messages that could be directly output to the digital printer and printed on thermally responsive paper substrates.

The printer module (Brother P-Touch Home & Hobby™) was modified from its original form of a label printer to become an attachment described above. All of the internal mechanical parts were removed and disconnected. The thermal print head was dismounted, transformed and remounted on the base of a standard cell phone. The thermal print head was mechanically machined so that the heating element strip became a small 0.5 by 0.75 pad. The thermal print head was kept connected to the original printer electronics through the attached connector cable strip. The print head was angled at 30 degrees with respect to the phone body. This angle was optimal for inducing contact between the thermal print array and a printable substrate.

A parallel adapter was created between the phone and the printer electronics such that text messages stored in the phone's memory could be sent to the printer memory. Electronic signaling was accomplished where printing was initiated using a send command from the phone's keypad.

Printable substrates included thermal papers mounted or coated on the backside of business cards, standard paper stock thermal papers, and suitable sheet sizes compatible with the use, transport and functionality of the cell phone. A typed in phrase was printed exactly in sequence as was logged into the device. Digital printing was accomplished using several different x, y sequence motions. Wording could be printed linearly or non-linearly. Phrases could be made straight or waved. Lettering could be compressed or expanded depending on the rate of motion applied to the thermal print head as it traversed the color-shift print paper.

### Example

### Integrated Remote Digital Printer Attached to and Used with a Personal Digital Assistant (PDA)

A remote digital printer was adapted to a Black Berry™ PDA such that the printer was attached directly to the base of a PDA. The PDA/printer became one unit where messages and outputs could be directly printed from the PDA by simply moving the base of the PDA/printer by hand over a printable paper substrate. Hand motion along with contact at the base of the printer lead to clearly printed messages down loaded from the phone.

The printer was connected to a parallel output from the PDA. The printer was powered with its own battery source independent of the PDA battery. The touchpad from the PDA was used to input text messages that could be directly output to the digital printer and printed on thermally responsive paper substrates.

The printer module (Brother P-Touch Home & Hobby™) was modified from its original form of a label printer to become an attachment described above. All of the internal mechanical parts were removed and disconnected. The thermal print head was dismounted, transformed and remounted on the base of PDA. The thermal print head was mechanically machined so that the heating element strip became a small 0.5 by 0.75 pad. The thermal print head was kept connected to the original printer electronics through the attached connector cable strip. The print head was angled at 30 degrees with respect to the PDA body. This angle was optimal for inducing contact between the thermal print array and a printable substrate.

A parallel adapter was created between the PDA and the printer electronics such that text messages stored in the PDA's memory could be sent to the printer memory. Electronic signaling was accomplished where printing was initiated using a send command from the PDA's touchpad.

Printable substrates included thermal papers mounted or coated on the backside of business cards, standard paper stock thermal papers, and suitable sheet sizes compatible with the use, transport and functionality of the PDA. A typed in phrase was printed exactly in sequence as was logged into the device. Digital printing was accomplished using several different x, y sequence motions. Wording could be printed linearly or non-linearly. Phrases could be made straight or waved. Lettering could be compressed or expanded depending on the rate of motion applied to the thermal print head as it traversed the color-shift print paper. Printable substrates include thermal printable pressure sensitive labels which could first be attached to a surface such as a box or inventory container and subsequently be printed with an output from the PDA/printer device.

The PDA/printer combination found use for a variety of inventory control, mail delivery, food-service and preparation environments for documenting time of use and time food may perish, libraries, pharmaceutical product inventory, pharmacy medicinal documentation, physician patient monitoring, stock trading, in-store promotions and inventory documentation, on-demand receipts and coupons, ticketing, law enforcement for documentation of crime scenes and ticketing, and the like.

### Example

### Computer Peripheral Digital Pen Printing Stylus for Analog/Digital Printing Effects

A hand-held digital printing pen stylus was constructed and interfaced with a laptop computer. The digital printing pen was prepared as described above by modifying a hand-held label printer (Brother P-Touch Home & Hobby™). All of the internal mechanical parts were removed and disconnected. The thermal print head was dismounted and transformed so that the print head was free with a full range of motion. The thermal print head was mechanically machined so that the heating element strip became a small 0.5 by 0.75 pad. The thermal print head was kept connected to the original printer with the attached connector cable strip. The print head was mounted on a plastic pen length stylus. The print head was angled at 30 degrees with respect to the pen length body. This angle was optimal for inducing contact between the thermal print array and a printable substrate.

The print head pad and connector cable were diverted out side the housing of the original printer and the printer cable was extended such that the hand-held digital printing stylus had a range of motion consistent with the length the connector cable (10 inch circumference range). Thermal print head was maintained with full operability from the keypad on the original label printer housing. The hand-held digital pen printing stylus had a full range of motion such that any given page within an attached book could be addressed and reached within the book. Print driver software and electronics were adapted to accept command language from parallel out puts from computer software packages utilized by the laptop computer.

For operation, a message could be typed on the laptop keyboard and sent using print commands to the hand-held digital pen printing stylus. Messages receive were directly printed out from the stylus print head on to thermally sensitive paper. The digital pen stylus printer configuration complete 3-dimensional motion of the full device and provided for complete dexterity of use of the stylus as easily as any writing pen. For printing, after a phrase had been typed into the device from the keyboard, printing was initiated by pressing the print button on the device body mounted in the book. The phrased was written with a brief delay sequence to provide for a 2 second delay prior to initiating the print sequence. The digital print head was placed in immediate contact with the surfaced of a color-shift print paper. An x, y motion was initiated across the print paper surface using the stylus pen like a normal pen or pencil.

A typed in phrase was printed exactly in sequence as was entered into the computer software package. Digital printing was accomplished using several different x, y sequence motions. Wording could be printed linearly or non-linearly. Phrases could be made straight or waved. Lettering could be compressed or expanded depending on the rate of motion applied to the thermal print head as it traversed the color-shift print paper.

Alternative communications formats between the computer and digital pen stylus driver electronics were also tested. Conveniently, wireless communications between the CPU and digital pen provided for a high degree of freedom to make hand printing motions free and independently of any connector cables. Graphics software packages utilized were of particular interest since graphics outputs could be modified using differed elected hand motions during the printing process.

Digitally encoded lines, borders, word, and pattern outputs could be further accentuated and modified post digital processing by the CPU using various analog x, y hand motions and speeds. Graphics could be distorted to create new artistic effects no easily possible using computer processing alone. The combination of computer digital processing and analog hand motions provided unique text and graphic outputs on demand which would have required significantly more complex software than was available using computer processing alone.

### Example

### Remote Digital Printer Attached to Digital Camera for Direct Picture Output

A remote digital printer was adapted to a digital camera such that the printer was attached directly to the parallel or serial port and housing of the camera. The camera/printer became one unit where messages and outputs could be directly printed from the cell phone by simply moving the base of the camera/printer by hand over a printable paper substrate. Hand motion along with contact at the base of the printer lead to clearly printed messages down loaded from the camera.

The printer was connected to a parallel output from the camera. The printer was powered with its own battery source independent of the camera battery. The command pad from the camera was used to input text messages that could be directly output to the digital printer and printed on thermally responsive paper substrates.

The printer module (Brother P-Touch Home & Hobby™) was modified from its original form of a label printer to become an attachment described above. All of the internal mechanical parts were removed and disconnected. The thermal print head was dismounted, transformed and remounted on the housing of a digital camera. The thermal print head was mechanically machined so that the heating element strip became a small 0.5 by 0.75 pad. The thermal print head was kept connected to the original printer electronics through the attached connector cable strip. The print head was angled with respect to the camera body for inducing optimal contact between the thermal print array and a printable substrate.

A parallel adapter was created between the camera and the printer electronics such that images messages stored in the camera's memory could be sent to the printer memory.

Electronic signaling was accomplished where printing was initiated using a send command from the camera's command.

Printable substrates included thermal papers mounted or coated on the backside of business cards, standard paper stock thermal papers, and suitable sheet sizes compatible with the use, transport and functionality of the camera. A typed in phrase was printed exactly in sequence as was logged into the device. Digital printing was accomplished using several different x, y sequence motions. Pictures could be printed linearly or non-linearly. Images could be compressed or expanded depending on the rate of motion applied to the thermal print head as it traversed the color-shift print paper.

### Example

### Digital Color-Shifting Sketching Device and Printing Medium

A digital sketching device was developed using a combination of the Etch-A-Sketch™ components and the Brother P-Touch 65™ components described above. Thermal print head from the label printer was attached to the x, y stylus of the sketching device such that the thermal print head came in direct contact with a piece of color-shift print coated paper attached to the transparent plastic cover.

Digital printing patterns were created in the x and y directions as the printer was initiated with a print sequence and the stylus was moved in the x and y directions. Various patterns and complex graphics could be achieved using the motion control and digital printing process. Further graphic and educational effects were achieved using papers with underlying printed graphics and overlying color-shifting agents to obscure the graphic until after the color shifting agent was triggered to a lighter revealing color. Notes and messages were revealed to be used as a means for testing and checking questions asked.

### Example

### Photo-Activated Digital Color-Shift Printing Medium on Skin

Digital printing on color-shift printing mediums on skin was accomplished using the remote digital fingertip printer device and method described in the example described (see EXAMPLE: Remote digital finger tip printer device). The fingertip print head and body was appropriately attached and held such that direct skin contact was convenient. Due to the compliant nature of skin, digital printing on skin could only be directly accomplished with a fully compliant print head system. Further, using a fingertip as an actuator provided excellent flexibility and ability to follow contours on skin and skeletal structure as wall as adaptable range and rate of motion.

A photo-activated color-shift print medium was formed on skin by application of a monomeric solution of a diacetylenic compound. The diacetylenic compound ethanolamide 5,7 hexadecadiynamide was dissolved at 250 mg/ml in ethanol (USP-NF grade). The solution was warmed to ensure complete solubility of the diacetylenic material. The solution was applied directly to skin using a cotton swap using a back and forth motion. The skin coating once dried was colorless. The diacetylenic material was colorized using a hand-held ultraviolet light (254 run). The material turned a red/magenta upon exposure. An area 0.5 inch wide and 2.5 inches long was colorized on the wrist/back of the hand. The colorized region gave a distinct wristband appearance.

When the color-shift print area was prepared for printing the digital finger tip printing device was used to print the message: DIGITAL SKIN. The thermal print head contact resulted in the apparent disappearance of color on from the printed letter region such that the contrast between the lettering, skin, and background color-shift print area gave rise to a high-resolution printed message directly in the applied skin region.

### Example

### Thermally-Sensitive Digital Color-Shift Printing on Skin

Color-shifting digital skin printed mediums may also posses thermochromic activity and be printed such that digital skin printed areas may also undergo a subsequent color changes by exposure to temperatures above and below body temperatures. For example, red magenta forms of the printed material can be warmed above body temperatures to reveal a red/orange coloration. Alternatively, the printed medium can be cooled below body temperatures to reveal deep purple-blue colorations.

Colored/digitally printed regions on skin formed as described (see EXAMPLE: Photo-activated digital color-shift printing medium on skin) were exposed to bath temperatures and running water (greater than 95 degrees F.). The digitally printed region turned an immediate red color from the initial magenta color. Subsequent exposure of the printed skin region to cool water (less than 62 degrees F.) resulted in a color-shift to a blue-purple color.

Utilization of reversible color-shifting digital skin printing mediums provides for a variety of sequential color changes and cosmetic appeal. Likewise, the digital skin printed region or message can serve to be informative to the person using the medium and associated message.

### Example

### Digitally Augmented Printing on Skin

Thermal printing process digitally applied directly to skin results in a transient augmentation of the skin surface. Wording, messages, symbols, text, graphics, tattoo art and the like can be formed directly and through digital printing using skin alone as the printing medium or in combination with a color shifting medium. Digital skin printing directly without a color-shift medium was accomplished as using the device as described (see EXAMPLE: Remote digital finger tip printer device). The remote digital finger printing device was programmed to print the wording DIRECT DIGITAL SKTN. A font size of 12 was used in bold. Initially within the first 12 hours, only a slight reddening occurred on the printed region of skin. By 24 hours, the wording DIRECT DIGITAL SKIN began to appear on the skin surface. The lettering became sharper over a 48 hour period. By day 3 after printing, a visible high-resolution scab appeared as the bolded letters. The scab was tinted darker than the surrounding skin regions giving rise to a clear. The darkened printed skin regions appeared as high-resolution lettering printed by a conventional printing method. The lettering did not appear as a scab, but as an attractive print pattern.

Alternatively, digital skin printing can be accomplished as described in the previous example in combination with a pre-colored color-shift medium. Printing was accomplished as above, but on a color-shift area as described (see EXAMPLE: Photo-activated digital color-shift printing medium on skin). In this case the lettering was initially contrasted by the color-shift in the color-shift medium and then subsequently 24 hours later by washing off the surrounding color-shift medium. After washing, the digitally printed skin region appeared similarly to digital skin printing directly without a color-shift medium described above.

### Example

### Digitally Augmented Cosmetic Skin Alteration

A cosmetic skin alteration was accomplished using the direct digital skin printing process (see EXAMPLE: Digitally augmented printing on skin). The hand held printer and print head were used to create mild transient tissue alteration on a wrinkled portion of skin. A simple dot pattern using small thermal dot pulses produced by the thermal print head was used to make small thermally induced scare between skin wrinkles. The dots were only to marginally visible if examined closely and only for a few days after the printing process was performed. Within one week no scabs or dots were visible by eye and the altered skin region was stretched tight compared with the adjacent wrinkled skin region. Various patterns were applied using increasing and decreasing dot densities and dot orderliness or disorderliness. Digital cosmetic skin alterations were accomplished to maximize resulting skin tightness and visual appeal.

The printer and digital printing process can be used for a variety of skin alterations including wrinkle reduction, blemish removal or masking, skin pigmentation changes, freckle alterations, birthmark alteration, transient body tattoos and the like.

### Example

### Digitally Adhered Cosmetic Dye Applications

Cosmetic powders and lotions can be thermally annealed to skin using the remote digital printing process. Initially a cosmetic base is applied directly to skin. The base is formulated to have a melting transition just below that of the thermal temperature achieve in the thermal print head of the remote digital printing device.

Once the cosmetic base is applied, the region of application is over printed with the remote digital printing device. The cosmetic base becomes thermally melted and adhered to directly to skin at the pixel locations prompted by the thermal printer. Powders containing dyes were spread on skin prior to digital skin printing. Final colorations after printing included a combination of color due the thermal printing process and the adherent dyes used in the applied cosmetic powders.

Various colored patterns can be achieved on skin depending on the color utilized in the cosmetic base. Digital skin printing can be used to temporarily dye skin in a particular location to create temporary tattoos, hide blemishes, or create or change other characteristics of the skin area being augmented.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method of digital printing on a substrate, said method comprising:
moving a print head across at least a portion of said substrate in an analog manner.

2. The method according to claim 1, wherein said print head is moved across said substrate in a manner that varies with respect to at least the x direction.

3. The method according to claim 1, wherein said print head is moved across said substrate in a manner that varies with respect to both the x and y directions.

4. The method according to claim 1, wherein said print head is moved across said substrate in a manner that varies with respect to rate in at least one of the x and y directions.

5. The method according to claim 4, wherein said print head is moved across said substrate in a manner that varies with respect to rate in both of the x and y directions.

6. The method according to claim 1, wherein said print head is moved across said substrate in a non-linear manner.

7. The method according to claim 1, wherein said print head is moved across said substrate in a curvilinear manner.

8. The method according to claim 1, wherein movement of said print head across said substrate is manually controlled.

9. The method according to claim 8, wherein said manually controlled movement is directly manually controlled.

10. The method according to claim 8, wherein said manually controlled movement is indirectly manually controlled.

11. The method according to claim 1, wherein said print head is part of a device in which said print head has full range of motion in at least x and y directions.

12. The method according to claim 11, wherein said print head is part of a device in which said print head has full range of motion in the x, y and z directions.

13-23. (canceled)

24. A device for printing on a substrate, said device comprising a print head that can move across at least a portion of said substrate in an analog manner.

25. The device according to claim 24, wherein said print head can move across said substrate in a manner that varies with respect to at least the x direction.

26. The device according to claim 24, wherein said print head can move across said substrate in a manner that varies with respect to both the x and y directions.

27. The device according to claim 24, wherein said print head can move across said substrate in a manner that varies with respect to rate in at least one of the x and y directions.

28. The device according to claim 27, wherein said print head can move across said substrate in a manner that varies with respect to rate in both of the x and y directions.

29. The device according to claim 24, wherein said print head can move across said substrate in a non-linear manner.

30. The device according to claim 24, wherein said print head can move across said substrate in a curvilinear manner.

31. The device according to claim 24, wherein said device provides for manual control of said print head movement.

32. The device according to claim 31, wherein said device provides for direct manual control of said print head movement.

33. The device according to claim 31, wherein said device provides for indirect manual control of said print head movement.

34. The device according to claim 31, wherein said print head has full range of motion in at least x and y directions.

35. The device according to claim 34, wherein said print head has full range of motion in the x, y and z directions.

36-46. (canceled)
